(19) United States
(12) Patent Application Publication
(10) Pub. No.: US 2002/0018331 A1
(43) Pub. Date: Feb. 14, 2002

(54) Circuit breaker

(75) Inventor: Hideo Takahashi, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 09/887,097

(22) Filed: Jun. 25, 2001

(30) Foreign Application Priority Data
Jun. 28, 2000 (JP) P2000-194753

(51) Int. Cl. H02H 5/04

(52) U.S. Cl. 361/103; 361/264

(57) ABSTRACT

A circuit breaker surely and quickly disconnects a circuit. If an abnormality occurs when the controller (70) is operating normally, the controller provides an abnormality signal to ignite an igniter (29), which heats a heating agent (27) filled in a thermite case (26). Heat from the thermite case melts a retainer (45), and a compressed spring (39a) in the retainer ejects the thermite case. This electrically disconnects the thermite case (26) from first and second bus bars (11a, 19a), thereby quickly and surely cutting a circuit. If the controller (70) fails to disconnect the circuit, the controller generates heat to make a temperature detective switch (71) conductive to pass current from a secondary power source (80) to a resistor (30b) of the igniter (29). The resistor generates heat to ignite an igniting agent (30a) filled in the igniter, thereby surely and quickly cutting the circuit.

### BACKGROUND OF THE INVENTION

1. Field of the Invention

The present invention relates to a circuit breaker for quickly breaking an electric circuit.

2. Description of the Related Art

A vehicle has an electric system involving a battery, load such as a power window, and a wire harness arranged between the battery and the load. If the load or wire harness causes an abnormality, a large-current fuse connected between the battery and the wire harness must be blown to disconnect the battery from the wire harness to protect the load and wire harness from burning.

The large-current fuse melts only when a current greater than a threshold set for the fuse passes through the fuse. If a current produced by an abnormality in the power window or wire harness is smaller than the threshold, the fuse will not melt. To cope with this problem and to disconnect the battery from the wire harness if a large current close to the fuse threshold continuously flows, various protective devices have been developed.

FIG. 1 is a sectional view showing a typical protective device employing a bimetal. In FIG. 1, a housing 103 is made of insulating resin and forms a fuse container 102 at an upper part thereof. A cap 113 closes and opens the fuse container 102. A power source terminal 105 is in a lower part of the housing 103 and has a top end protruding in the fuse container 102 and a bottom end protruding outside and connected to a positive terminal of a battery 104. A load terminal 109 is in the lower part of the housing 103 and has a top end protruding in the fuse container 102 and a bottom end protruding outside and connected to a wire 107 of a wire harness 106 connected to a load 108. A fuse 110 made of fusible metal is in the fuse container 102. An end of the fuse 110 is connected to the top end of the terminal 105, and the other end thereof is connected to the top end of the terminal 109. An intermediate terminal 111 is in the lower part of the housing 103 between the terminals 105 and 109. An exposed bottom end of the terminal 111 is connected to a negative terminal of the battery 104. A top end of the terminal 111 is connected to a bimetal 112, which faces the fuse 110.

When an ignition switch of a vehicle in which the protective device 101 is installed is turned on and if the load 108 or the wire harness 106 causes an abnormality to pass a current exceeding a threshold value through the fuse 110, the fuse 110 heats and melt to protect the load 108 and wire harness 106.

If a large current below the threshold passes through the fuse 110, the current heats the fuse 110 to heat and deform the bimetal 112. Due to the deformation, a front end of the bimetal 112 touches the fuse 110 to pass a large short-circuit current through the fuse 110 to blow the fuse 110.

FIG. 2 is a sectional view showing another protective device 121. The protective device 121 has a housing 122 made of insulating resin. The housing 122 has a power source terminal 124 buried in one side. A bottom end of the terminal 124 is connected to a positive terminal of a battery 123. A load terminal 128 is buried in the other side of the housing 122 and has a bottom end connected to a wire 126 of a wire harness 125 connected to a load 127. A conductive fuse 129 is made of fusible metal and has a U-shape. The fuse 129 is covered with a heat-resisting coat 130 to form a cable 131. Ends of the cable 131 are connected to the tops of the terminals 124 and 128, respectively. A coil 132 is wound around the cable 131 and the coil 132 is made of shape-memory alloy that restores an original shape to squeeze the cable 131 when heated to a predetermined temperature. An external terminal 133 is arranged outside the housing 122 and has a top end connected to an end of the coil 132 and a bottom end connected to a negative terminal of the battery 123.

When an ignition switch of a vehicle with the protective device 121 installed is turned on and if the load 127 or the wire harness 125 causes an abnormality to pass a current greater than a threshold through the fuse 129, the fuse 129 heats and melt to protect the load 127 and wire harness 125.

If a large current below the threshold passes through the fuse 129 due to an abnormality in the load 127 or wire harness 125, the current heats the fuse 129 to heat the coil 132. When the coil 132 is heated to the predetermined temperature, the coil 132 changes from a martensite phase to a parent phase to bite the coat 130 that has been softened by the heat from the fuse 129. When the coil 132 touches the fuse 129, a large short-circuit current flows through and blows the fuse 129.

FIG. 3 is a perspective view showing a fuse 201 for a fusible link. The fuse 201 consists of a fusible body 202 made of high-melting-point metal, a holder 202a, and a fusible piece 203 made of low-melting-point metal and held by the holder 202a. The low-melting-point metal diffuses to form an alloy to improve fusing characteristics.

### SUMMARY OF THE INVENTION

The protective device 101 of FIG. 1 employs the bimetal 112 made of two metals having different thermal expansion coefficients bonded together to respond to a current passing through the fuse 110. When the current passing through the fuse 110 changes, then the bimetal 112 deforms to change a circuit breaking time. When an abnormality occurs to intermittently pass a large current, however, if the temperature of the fuse 110 will not exceed a certain level to activate the bimetal 112, then the wire harness 106 and load 108 will exceedingly heat before the protective device 101 breaks the circuit.

The protective device 121 of FIG. 2 employs the shape memory coil 132 to respond to a current flowing through the fuse 129. When the current passing through the fuse 129 changes, then the coil 132 deforms to change a circuit breaking time.

If an abnormality occurs to intermittently pass a large current, the temperature of the fuse 129 will not exceed a certain level to activate the coil 132, and therefore, the wire harness 125 and load 127 will excessively be heated before the protective device 121 breaks the circuit.

The materials that form the bimetal 112 and coil 132 of the protective devices of FIGS. 1 and 2 have thermal reaction periods that are dependent on currents passing through the fuses 110 and 129. These materials are slow in circuit breaking operation in response to an abnormality such as an overcurrent.

The fuse 201 of FIG. 3 has a problem that the diffusing time of the low-melting-point metal of the fusible piece 203 to a copper alloy is dependent on a passing current. In addition, the diffusing time of the low-melting-point metal is long, and therefore, the fuse 201 is slow to react to an abnormality such as an overcurrent.

An object of the present invention is to provide a circuit breaker capable of surely and quickly breaking a circuit to protect electric parts. Even if a controller of the circuit breaker fails, the circuit breaker is capable of surely and quickly breaking a circuit by bypassing the controller.

In order to accomplish the object, the present invention provides a circuit breaker including a first terminal connected to a primary power source, a second terminal connected to a load, a conductive heater arranged between and in contact with the first and second terminals, an igniter energized from a secondary power source in response to an abnormality, to activate the heater, a resilient member arranged in the vicinity of or in contact with the heater to push the heater, a stopper stopping the resilient member from pushing the heater, the stopper being meltable if heated by the heater, an outer casing accommodating the resilient member, igniter, and heater, and a temperature sensitive switch having a first end connected to a first end of the igniter and a second end connected to a second end of the igniter through the secondary power source, to energize the igniter in response to an abnormal temperature.

The stopper forms a retainer that holds the resilient member in a compressed state, is attachable to and detachable from the outer casing, is in the vicinity of or in contact with the heater when attached to the outer casing, and melts if heated by the heater. The heater has a side wall that is in contact with ends of the first and second terminals through low-melting-point materials.

### BRIEF DESCRIPTION OF THE DRAWINGS

FIG. 1 is a sectional view showing a protective device with a bimetal according to a prior art;

FIG. 2 is a sectional view showing a protective device according to another prior art;

FIG. 3 is a perspective view showing a fuse of a fusible link according to still another prior art;

FIG. 4 is a sectional view showing a circuit breaker before breakage according to a first embodiment of the present invention;

FIG. 5 is an exploded perspective view showing the circuit breaker of the first embodiment;

FIGS. 6 and 7 are perspective views showing a retainer before and after breakage, of the circuit breaker of the first embodiment; and

FIG. 8 is a sectional view showing a circuit breaker before breakage according to a second embodiment of the present invention.

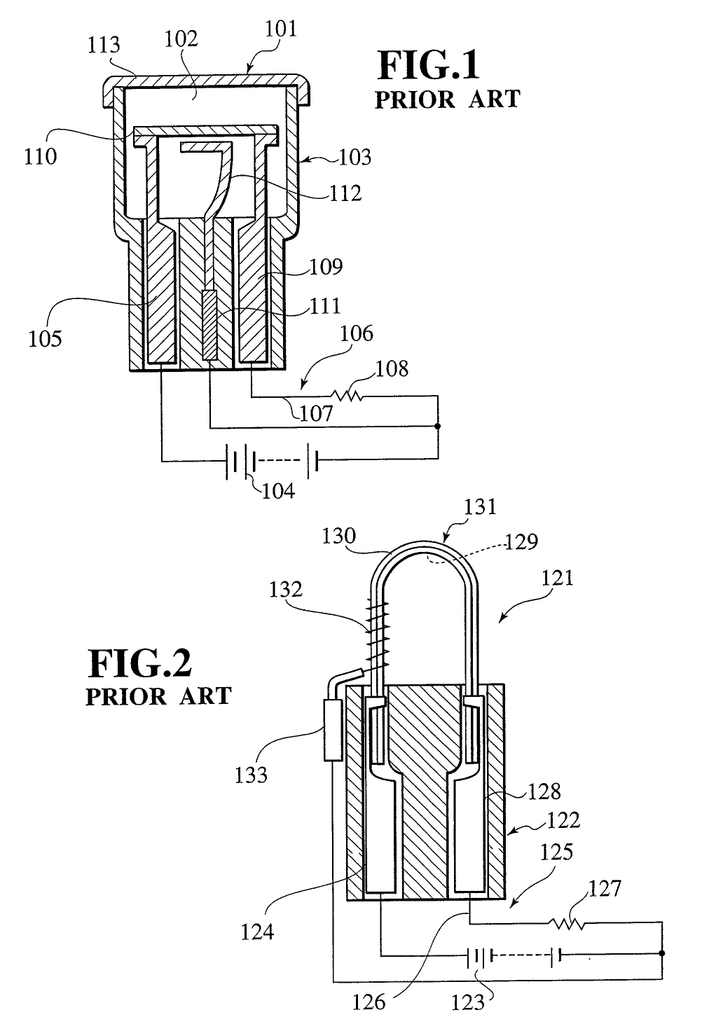

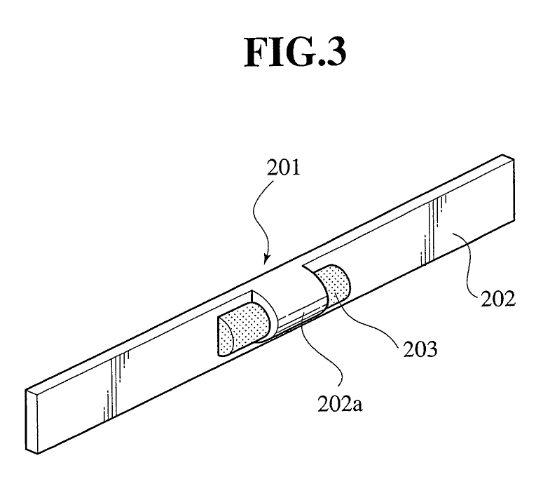

### DESCRIPTION OF THE PREFERRED EMBODIMENT

Various embodiments of the present invention will be described with reference to the accompanying drawings.

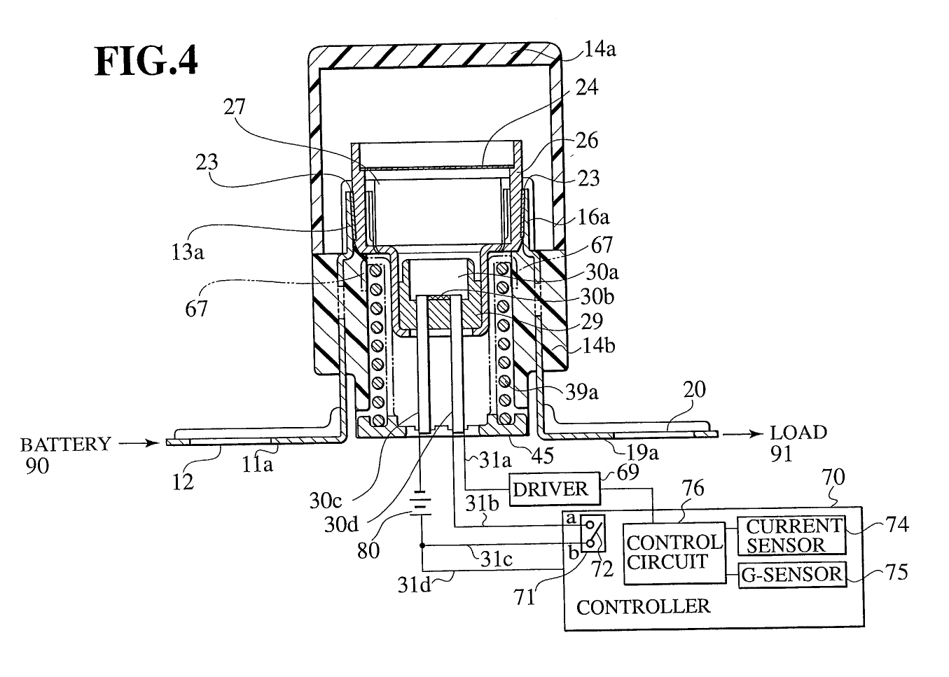

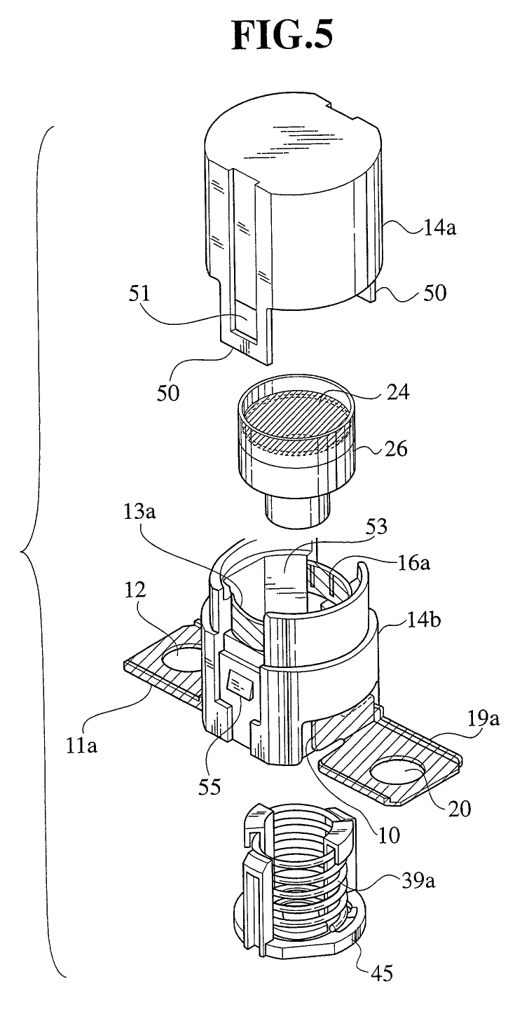

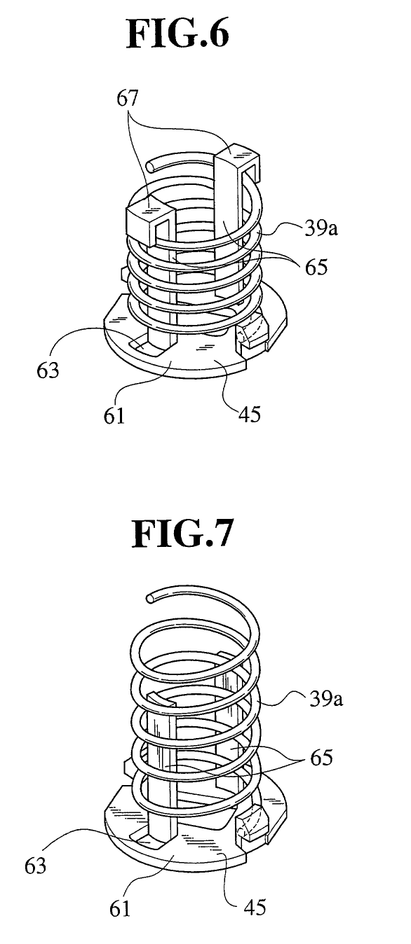

FIG. 4 is a sectional view showing a circuit breaker before breakage according to the first embodiment of the present invention, FIG. 5 is an exploded perspective view showing the circuit breaker, and FIGS. 6 and 7 are perspective views showing a retainer before and after breakage, contained in the circuit breaker.

The circuit breaker of the first embodiment is capable of breaking a circuit in response to an abnormal temperature, even if a controller, etc., of the circuit breaker fail to send an abnormality signal to an igniter to break the circuit.

In FIG. 4, a first bus bar 11a is made of, for example, copper or copper alloy and serves as a first terminal connected to a battery 90 (not shown). A second bus bar 19a is made of, for example, copper or copper alloy and serves as a second terminal connected to a load 91 (not shown). The bus bars 11a and 19a have no electric polarities.

In FIG. 5, a cap 14a has extensions 50 each having a square slot 51. A resin case 14b has tabs 55 to engage with the slots 51, to hold the cap 14a on the case 14b. The cap 14a and case 14b are made of insulating material such as resin (thermoplastic resin) and constitute an outer casing.

The case 14b has an opening 53 to receive a cylindrical thermite case 26. The thermite case 26 includes a heating agent 27 and an igniter 29. The heating agent 27 is covered with a lid 24.

The thermite case 26 is made of, for example, brass, copper, copper alloy, or stainless steel that has a good heat conductivity and does not melt with heat produced by the heating agent 27. The thermite case 26 is formed by, for example, metal drawing into a cylinder or a rectangular parallelepiped.

If an abnormality such as a collision occurs on a vehicle in which the circuit breaker of the first embodiment is installed, the igniter 29 is energized by a current passing through a lead 31a to ignite an igniting agent 30a, so that the heating agent 27 may generate heat by thermite reaction.

The first bus bar 11a has a circular hole 12, and the second bus bar 19a has a circular hole 20. The bus bars 11a and 19a are upwardly bent at nearly right angles into the case 14b, so that ends 13a and 16a of the bus bars 11a and 19a may be in contact with left and right parts of a side wall of the thermite case 26 through low-melting-point metals 23. The metals 23 may be made of solder having a melting point of 200° C. to 300° C.

The left and right parts of the side wall of the thermite case 26 are in contact with the metals 23, which are in contact with the ends 13a and 16a of the bus bars 11a and 19a. Namely, the bus bars 11a and 19a are electrically connected to each other through the metals 23 and thermite case 26. The metals 23 may be made of metal selected from Sn, Pb, Zn, Al, and Cu.

The heating agent 27 is a thermite agent containing, for example, metal oxide powder such as iron oxide (Fe₂O₃) powder and aluminum powder and the heating agent 27 causes a thermite reaction when heated and generates high heat. To avoid humidity, the heating agent 27 is sealed in the thermite case 26 made of metal. Instead of the iron oxide, the heating agent 27 may contain chrome oxide (Cr₂O₃) or manganese oxide (MnO₂).

The heating agent 27 may be a powdered mixture of at least one metal selected from B, Sn, FeSi, Zr, Ti, and Al, at least one metal oxide selected from CuO, MnO₂, Pb₃O₄, PbO₂, Fe₃O₃, and Fe₂O₃, and at least one additive selected from alumina, bentonite, and talc. This type of heating agent is easily ignited by the igniter 29 and quickly melts the metals 23.

A retainer 45 made of resin is arranged under the thermite case 26 in the opening 53 of the case 14b. The retainer 45 holds a spring 39a in a compressed state and is removably installed in the case 14b. The retainer 45 in the case 14b is in the vicinity of or in contact with the thermite case 26 and melts when the heating agent 27 produces heat. The retainer 45 is easy to attach to and detach from the case 14b.

In FIG. 6, the retainer 45 has a base 61, cuts 63 formed on the base 61, bodies 65 extending upright from the cuts 63, and stoppers 67 formed at top ends of the bodies 65, respectively. The stoppers 67 work to fit the retainer 45 to the case 14b.

The spring 39a is wound around the bodies 65, and a front part of the spring 39a is fitted to the stoppers 67 so that the spring 39a is compressed and held in the retainer 45. The igniter 29 has a pair of terminals 30c and 30d, a heating resistor 30b arranged between the terminals 30c and 30d, and the igniting agent 30a arranged in the vicinity of or in contact with the resistor 30b. The terminal 30d is connected to a controller 70 through the lead 31a and a driver 69. The controller 70 has a temperature sensitive switch 71, a current sensor 74, a collision sensor (G-sensor) 75, and a control circuit 76. The switch 71 may be arranged in the vicinity of the controller 70 instead of the inside of the controller 70.

The temperature sensitive switch 71 has terminals a and b and an arm 72. In response to a predetermined temperature, the arm 72 comes into contact with the terminal a to close the switch 71. To respond to the temperature, the switch 71 may have a bimetal, a thermistor, a temperature measuring resistor, etc. The current sensor 74 detects a current from the battery 90 to a load. For example, the current sensor 74 detects a current flowing between the first and second bus bars 11a and 19a. The G-sensor 75 detects shock due to a collision between the vehicle carrying the circuit breaker and another vehicle, or a rollover of the vehicle. If the current sensor 74 detects a current exceeding a threshold, or if the G-sensor 75 detects an acceleration exceeding a threshold, the control circuit 76 provides an abnormality signal to the driver 69, which activates the igniter 29.

The igniter terminal 30d is connected to the terminal a of the temperature sensitive switch 71 through a lead 31b. The igniter terminal 30c is connected to the terminal b of the switch 71 through a secondary power source 80 and a lead 31c. The secondary power source 80 supplies power to the controller 70 through a lead 31d.

According to the first embodiment, the circuit breaker may have a voltage sensor for detecting an exceeded voltage and a temperature sensor for detecting a temperature. The outputs of the voltage and temperature sensors are supplied to the control circuit 76 to control the driver 69.

The operation of the circuit breaker according to the first embodiment will be explained. In a normal state, the first and second bus bars 11a and 19a are electrically connected to each other through the metals 23 and thermite case 26, to supply current from the battery 90 (not shown) to the load 91 (not shown).

If an abnormality occurs in the vehicle when the current sensor 74, G-sensor 75, control circuit 76, etc., are sound, an abnormality signal will be generated to activate the igniter 29. The abnormality in the vehicle will cause an exceeded current to flow between the bus bars 11a and 19a, and the current sensor 74 detects the overcurrent. If the detected overcurrent is above a threshold, the control circuit 76 provides an abnormality signal to the driver 69, which supplies current to the resistor 30b through the lead 31a.

As a result, the resistor 30b generates heat to increase the temperature of the resistor 30b above, for example, 350° C. to ignite the igniting agent 30a. Then, the heating agent 27, i.e., the thermite agent reacts to generate heat due to the following thermite reaction (1):

Fe₂O₃+2Al→Al₂O₃+2Fe+1.62 MJ (1)

This thermite reaction heats the thermite case 26. Due to heat from the heating agent 27 and thermite case 26, the low-melting-point metals 23 melt. At the same time, the heat from the thermite reaction melts the stoppers 67 that are holding the compressed spring 39a in the retainer 45. As a result, the spring 39a ejects the thermite case 26 toward the cap 14a.

This electrically disconnects the thermite case 26 from the bus bars 11a and 19a. In this way, an abnormality, once it is detected in the vehicle in which the circuit breaker is installed, automatically triggers the above-mentioned electrical and chemical reactions to surely and quickly cut an electrical circuit in the vehicle and protect electric parts.

If any one of the current sensor 74, G-sensor 75, and control circuit 76 fails to sense or send information of abnormality, no abnormality signal will be sent to the igniter 29 on the occurrence of an abnormality in the vehicle. In this case, the temperature of the controller 70 increases due to the failure of the current sensor 74, G-sensor 75, or control circuit 76. Then the temperature sensitive switch 71 in the controller 70 will close when the temperature of the controller 70 exceeds the threshold of the switch 71.

As a result, the switch 71 passes current from the secondary power source 80 to the igniter terminal 30d, resistor 30b, and igniter terminal 30c and this makes the resistor 30b generate heat. When the temperature of the igniting agent 30a exceeds, for example, 350° C., the igniting agent 30a ignites to initiate the above-mentioned reactions.

In this way, even if the controller 70 fails to disconnect the circuit, the circuit can surely and quickly be cut in response to an abnormal temperature in the controller 70. Even if the sensors such as the current sensor 74 malfunction, the circuit will be cut in response to detecting the abnormal temperature.

The stoppers 67 are internal relative to the spring 39a. Namely, the fulcrums of the stoppers 67 on the retainer 45 are inside of the acting points of the string 39a on the stoppers 67. As a result, the spring 39 inwardly pushes the stoppers 67, to strongly fit the retainer 45 to the thermite case 26. This realizes good heat conduction from the thermite case 26 to the retainer 45 to efficiently melt the stoppers 67. Pushing the retainer 45 against the thermite case 26 stabilizes and reduces electric resistance between them, to stably supply current from the battery 90 to the load 91 during a normal operation.

Only by inwardly flexing the stoppers 67, the spring 39a can easily be assembled to the retainer 45. The retainer 45 with the spring 39a is easily fitted to the case 14b. Since the spring 39a is retained in the retainer 45, the spring 39a applies no force to the low-melting-point metals 23 serving as contacts between the bus bars 11a and 19b and the thermite case 26. This improves the reliability of these contacts. The retainer 45 with the spring 39a is merely inserted into the opening 53 of the case 14b, to simplify the assembling work of the circuit breaker as a whole. If the circuit breaker disconnects a circuit on the occasion of an abnormality, only the retainer 45 and thermite case 26 are replaced with new ones and the case 14b is reused to rebuild the circuit breaker. The cap 14a set on the case 14b prevents the thermite case 26 from jumping out of the case 14b when the circuit breaker operates to cut a circuit. This prevents any person from getting burned.

A circuit breaker according to the second embodiment of the present invention will be explained. This circuit breaker is capable of surely cutting a circuit in response to an abnormal temperature on a bus bar even if a controller of the circuit breaker fails to provide an abnormality signal to an igniter.

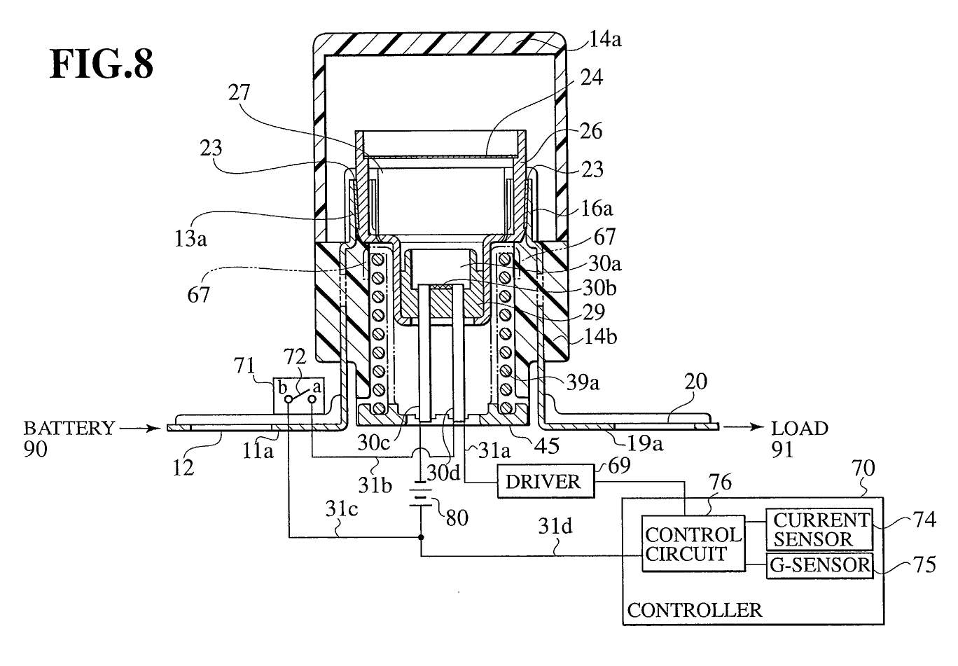

FIG. 8 is a sectional view showing the circuit breaker according to the second embodiment. The second embodiment differs from the first embodiment in that the second embodiment arranges a temperature sensitive switch 71 on or in the vicinity of a first bus bar 11a. This switch 71 may be arranged on or in the vicinity of a second bus bar 19a instead of the first bus bar 11a. The other parts of the second embodiment are the same as those of the first embodiment, and therefore, the explanations of such parts are omitted by representing like parts with like reference numerals.

The operation of the circuit breaker according to the second embodiment will be explained. If a current sensor 74, a G-sensor 75, a control circuit 76, etc., in or around a controller 70 are sound and if an abnormality occurs in a vehicle in which the circuit breaker is installed, an abnormality signal is sent to activate an igniter 29, and the actions explained in the first embodiment follow.

If any one of the current sensor 74, G-sensor 75, control circuit 76, etc., fails and if an abnormality occurs in the vehicle, no abnormality signal is sent to activate the igniter 29. In this case, the abnormality causes an overcurrent exceeding a threshold to flow through the first bus bar 11a. The overcurrent increases the temperature of the bus bar 11a to make the temperature sensitive switch 71 arranged at the bus bar 11a conductive.

As a result, the switch 71 passes current from a secondary power source 80 to an igniter terminal 30d, a heating resistor 30b, and an igniter terminal 30c. Due to this current, the resistor 30b generates heat to ignite an igniting agent 30a. Thereafter, the actions explained above take place.

Even if the controller 70 is unable to disconnect a circuit, the circuit breaker according to the second embodiment surely and quickly disconnects the circuit in response to an abnormal temperature at a location where the circuit breaker is installed. Consequently, the second embodiment ensures a circuit breaking function like the first embodiment.

The present invention is not limited to the first and second embodiments. Although each of the first and second embodiments employs the compressed spring 39a and low-melting-point metals 23 to break a circuit when the retainer 45 and metals 23 are melted, the present invention may omit the metals 23 and may employ only the retainer 45 to cut a circuit. The retainer 45 may be made of not only resin but also low-melting-point metal such as solder having a melting point of, for example, 200° C. to 300° C. so that the retainer 45 may melt due to heat generated by the heating agent 27.

When the controller 70 fails to disconnect a circuit, the first and second embodiments cut the circuit in response to an abnormal temperature on a bus bar or in the controller 70 with the use of the temperature sensitive switch 71. The present invention may break a circuit in response to an abnormal current or an abnormal voltage when the controller 70 fails.

This application claims benefit of priority under 35USC §119 to Japanese Patent Applications No. 2000-194753, filed on Jun. 28, 2000, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A circuit breaker for supplying current from a primary power source to a load through a circuit and disconnecting the circuit in response to an abnormality, comprising:
a first terminal connected to the primary power source and a second terminal connected to the load;
a conductive heater arranged between and in contact with the first and second terminals;
an igniter energized from a secondary power source in response to the abnormality, to activate the heater;
a resilient member arranged to push the heater;
a stopper stopping the resilient member from pushing the heater, the stopper being meltable if heated by the heater;
an outer casing accommodating the resilient member, igniter, and heater; and
a temperature sensitive switch having a first end connected to a first end of the igniter and a second end connected to a second end of the igniter through the secondary power source, to energize the igniter in response to an abnormal temperature.

2. The circuit breaker of claim 1, further comprising
a controller for controlling power supplied from the secondary power source to the igniter, the controller having a first end connected to the first end of the igniter and a second end connected to the second end of the igniter through the secondary power source, the controller supplying power from the secondary power source to the igniter in response to the abnormality.

3. The circuit breaker of claim 2, wherein
the temperature sensitive switch is arranged inside or in the vicinity of the controller.

4. The circuit breaker of claim 1, wherein
the temperature sensitive switch is arranged in the vicinity of one of the first and second terminals.

5. The circuit breaker of claim 1, wherein the igniter comprises:
a resistor arranged between the first and second ends of the igniter; and
an igniting agent arranged operatively with the resistor.

6. The circuit breaker of claim 1, wherein
the stopper forms a retainer that holds the resilient member in a compressed state, the retainer being attachable to and detachable from the outer casing, being positioned in the outer casing operatively with the heater, and having parts that melt due to heat generated by the heater.

7. The circuit breaker of claim 1, wherein
the heater has a side wall, which is in contact with ends of the first and second terminals through low-melting-point materials.
